(19) United States
(12) Patent Application Publication
(10) Pub. No.: US 2020/0275521 A1
(43) Pub. Date: Aug. 27, 2020

(54) 2G Over IP Architecture

(71) Applicant: Parallel Wireless, Inc., Nashua, NH (US)

(72) Inventors: Rajesh Kumar Mishra, Westford, MA (US); Yang Cao, Westford, MA (US); Kaitki Agarwal, Westford, MA (US); Eugina Jordan, Leominster, MA (US); Fernando Cerioni, Lancaster, MA (US)

(21) Appl. No.: 16/801,144

(22) Filed: Feb. 25, 2020

Related U.S. Application Data
(60) Provisional application No. 62/810,317, filed on Feb. 25, 2019.

(51) Int. Cl. H04W 84/04; H04W 84/18; H04W 88/12; H04W 24/02; H04W 88/16

(52) U.S. Cl. CPC H04W 84/045; H04W 84/18; H04W 88/16; H04W 24/02; H04W 88/12

(57) ABSTRACT

Systems, methods and computer software are disclosed for providing a virtual machine for 2G networks; wherein the virtual machine provide a plurality of virtualized network functions (VNFs).

### CROSS-REFERENCE TO RELATED APPLICATIONS

This application claims priority under 35 U.S.C. § 119(e) to U.S. Provisional Pat. App. No. 62/810,317, filed Feb. 25, 2019, titled “2G Over IP Architecture,” which is hereby incorporated by reference in its entirety for all purposes. This application hereby incorporates by reference, for all purposes, each of the following U.S. Patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. In addition, U.S. Patent Publication Nos. 20190364616A1 and US20180242396A1; U.S. patent application Ser. No. 16/733,947; and International Patent Publication No. WO2019209922 are also hereby incorporated by reference in their entirety.

The present application hereby incorporates by reference U.S. Pat. App. Pub. Nos. US20110044285, US20140241316; WO Pat. App. Pub. No. WO2013145592A1; EP Pat. App. Pub. No. EP2773151A1; U.S. Pat. No. 8,879,416, “Heterogeneous Mesh Network and Multi-RAT Node Used Therein,” filed May 8, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/777,246, “Methods of Enabling Base Station Functionality in a User Equipment,” filed Sep. 15, 2016; U.S. patent application Ser. No. 14/289,821, “Method of Connecting Security Gateway to Mesh Network,” filed May 29, 2014; U.S. patent application Ser. No. 14/642,544, “Federated X2 Gateway,” filed Mar. 9, 2015; U.S. patent application Ser. No. 14/711,293, “Multi-Egress Backhaul,” filed May 13, 2015; U.S. Pat. App. No. 62/375,341, “S2 Proxy for Multi-Architecture Virtualization,” filed Aug. 15, 2016; U.S. patent application Ser. No. 15/132,229, “MaxMesh: Mesh Backhaul Routing,” filed Apr. 18, 2016, each in its entirety for all purposes, having attorney docket numbers PWS-71700US01, 71710US01, 71717US01, 71721US01, 71756US01, 71762US01, 71819US00, and 71820US01, respectively. This application also hereby incorporates by reference in their entirety each of the following U.S. Pat. applications or Pat. App. Publications: US20150098387A1 (PWS-71731US01); US20170055186A1 (PWS-71815US01); US20170273134A1 (PWS-71850US01); US20170272330A1 (PWS-71850US02); and Ser. No. 15/713,584 (PWS-71850US03). This application also hereby incorporates by reference in their entirety U.S. patent application Ser. No. 16/424,479, “5G Interoperability Architecture,” filed May 5, 2019; and U.S. Provisional Pat. Application No. 62/804,209, “5G Native Architecture,” filed Feb. 11, 2019.

This application hereby incorporates by reference, for all purposes, each of the following publications in their entirety for all purposes: U.S. Pat. App. Pub. Nos. US20140133456A1, US20150094114A1, US20150098385A1, US20150098387A1, US20160044531A1, US20170013513A1, US20170019375A1, US20170026845A1, US20170048710A1, US20170055186A1, US20170064621A1, US20170070436A1, US20170077979A1, US20170111482A1, US20170127409A1, US20170171828A1, US20170181119A1, US20170202006A1, US20170208560A1, US20170238278A1, US20170257133A1, US20170272330A1, US20170273134A1, US20170288813A1, US20170295510A1, US20170303163A1, US20170347307A1, US20180123950A1, and US20180152865A1; and U.S. Pat. Nos. 8,867,418, 8,879,416, 9,107,092, 9,113,352, 9,232,547, and 9,455,959.

### BACKGROUND

Parallel Wireless's all-G software platform empowers MNOs to cost-effectively connect everyone everywhere. Our solution is the world's first end-to-end software-enabled wireless platform that unifies networks across all-Gs to create a fully orchestrated, automated, interoperable, and future-proof network for all use cases. In fact, our innovation in creating an Open Network any-G solution was recognized at TIP summit by Vodafone for excellence in all components of the heterogeneous network, touching upon 2G, 3G, and 4G and spanning across both hardware and software sides of the network.

GSM/2G is a mature telecom technology primarily used for Voice Service. GSM/2G has widespread use throughout the world and extensive coverage. GSM service is in more than 200 different countries, which makes it easy to use a GSM phone in those countries. Many operators use GSM/2G to deliver voice services; for example, operators in developing countries. A GSM cell phone will work with any other GSM service anywhere in the world if it has the same frequency. GPRS technology brings many benefits for users and network operators alike over the basic GSM system. In 2020 it is estimated that there will be nearly 39% more 2G connections worldwide than there are 4G. With so many people still using 2G, you would think operators would be eager to capture this market share, yet few are.

### SUMMARY

A wireless network system is described. The wireless network system includes a 2G Base Station Subsystem (BSS) managing a circuit switched (CS) path wherein a remote gateway (RGW) runs inside a converged wireless system (CWS) and handles radio resource management functions, the RGW including a standardized interface towards the BTS software within the CWS, and wherein communication between the BTS layers and RGW layers uses Abis over IP interface. The 2G BSS manages a packet switched path, wherein the CWS hosts a Packet Control Unit (PCU) function.

For the use case of deploying rural networks, as many as forty percent of these remote areas will still be running 2G in 2020. This equates to roughly 360 million 2G users. What most people find surprising about our 2G solution is how recently we announced it since at the time of its launch in November 2017, most people were thinking about 5G. However, in 2020 it is estimated that there will be nearly thirty-nine percent more 2G connections worldwide than there are 4G.

In one embodiment, a virtualized Hetnet Gateway (HNG) for a 2G network, comprises a processor; and a memory coupled to the processor, the memory containing instructions which, when executed by the processor, cause the base station to provide a virtual machine for 2G networks; wherein the virtual machine provide a plurality of virtualized network functions (VNFs).

In another embodiment, a method comprises causing a processor to provide a virtual machine for 2G networks; wherein the virtual machine provide a plurality of virtualized network functions (VNFs).

In another embodiment, a non-transitory computer-readable medium containing instructions which, when executed at a processor, causes the processor to perform steps comprising: providing a virtual machine for 2G networks; wherein the virtual machine provide a plurality of virtualized network functions (VNFs).

### BRIEF DESCRIPTION OF THE DRAWINGS

FIG. 1 is a diagram of a modernized legacy 2G network, in accordance with some embodiments.

FIG. 2 is a diagram showing satellite and microwave backhaul, in accordance with some embodiments.

FIG. 3 is a diagram showing 2G architecture simplification, in accordance with some embodiments.

FIG. 4 is a diagram showing All G software platform, in accordance with some embodiments.

FIG. 5 is a schematic network architecture diagram for various radio access technology core networks.

FIG. 6 is an enhanced eNodeB for performing the methods described herein, in accordance with some embodiments.

FIG. 7 is a coordinating server for providing services and performing methods as described herein, in accordance with some embodiments.

### DETAILED DESCRIPTION

Rural 2G networks are challenging to deploy due to high cost of not only hardware, but also supporting infrastructure as well as cost to optimize, maintain, and upgrade. What we've found is that the cost of power can be as much as 25% per site; providing power and backhaul to the site can also add to the deployment times if these utilities are not already in place. Traditional solutions also do not provide adequate coverage areas, requiring increased investment to expand the network and more time, effort, and money to optimize with RF planning and drive tests. Lastly, there is a limited user base in these areas which makes it undesirable for operators to build out networks when they won't see much ROI, especially when you also take into account that most operators are looking ahead to 5G and do not want to waste their investment on what they see as an obsolete technology.

By taking the software-first approach, Parallel Wireless creates a unified architecture that is able to address these challenges when it comes to deploying not just 2G, but all-G's in all use cases. During this demo, we will explain how our software simplifies installation and maintenance, how our software-defined radios make it easier to connect people around the world, and how our software platform provides a 5G-ready migration strategy regardless of what G you are using today. As a result, we enable the lowest TCO solution that allows you, the operator, to enter new markets such as rural 2G markets.

Because of our virtualized architecture, we were able to bring the concepts of SDN and NFV to 2G networks to create the world's first virtualized 2G solution! When you take a look at our network architecture, you'll notice the centralized location of our software platform, HetNet Gateway or HNG. Because of HNG's logical placement between RAN and core, it has a holistic, bird's-eye view of the entire network to make our network self-configuring and self-optimizing. What this enables is hands-free automation of the network to create OPEX savings for the operator and an improved, seamless experience for the end-user, regardless of which technology they are using. Because we make the 2G network IP-based and by being completely 3GPP standards compliant, this virtualized software approach enables an open network architecture that also enables interoperability.

Of course, since we are still working with RF signals, the hardware component is still essential. The beauty of our approach is the software we developed working hand-in-hand with our hardware to make any commodity hardware more capable and intelligent. With our CWS hardware, we integrate the entire base station site onto one small form factor, which reduces the number of elements to purchase and install while reducing the size of the cell site, which can reduce licensing fees as well. Although our hardware is one the smallest, lightest macrocells on the market with the best-in-class power efficiency, the real value is provided via HetNet Gateway.

With HNG, we can provide any combination of 2G, 3G, and 4G on the same unit. This crucial capability is what allows us to modernize legacy 2G networks and provide a clear, simple, low-cost migration plan that extends the investment for tomorrow while meeting subscriber needs of today. With our Converged Wireless System, or CWS, operators can fill coverage gaps of 2G and with a simple software-upgrade, switch that CWS to provide 3G or 4G access when the devices become more affordable or when end-users' needs change.

HNG makes this any-G hardware completely IP-based, so it can work with any IP-based backhaul. As you accurately pointed out in the survey, providing backhaul can be extremely difficult and expensive when dealing with rural 2G markets; by enabling flexible backhaul via HNG, the CWS can work with satellite or microwave backhauls to drive down the cost.

HNG acts as a virtual machine by taking many of your essential network functions such as BSC, RNC, and SON and virtualizing them as VNFs on one low-cost server. As a result of this approach, you receive all your normal network functionalities, only they are more efficient as they no longer operate in individual silos and you can easily manage, add, or remove these functions as you go, similar to how you would apps on your phone. Because these components are now virtualized instead of coming as additional servers (which, by the way, is usually charged as additional costs billed ON TOP of what you were initially quoted), but having these elements as VNFs enables them to run on the same server in your data center or can even be deployed on small, ruggedized servers locally on-site. This increase deployment flexibility while also providing an additional layer of resilience by having a local option deployed as a failsafe. The other innovative thing about virtualizing network functions is that it can provide other benefits such as further driving down cost: one example of this is with our vBSC, which reduces the cost of backhaul when using satellite by powering down the backhaul link automatically during nonpeak hours to reduce operational expenses.

Another essential VNF on HNG is our real-time SON. With Parallel Wireless SON on HNG, we can make network adjustments in real-time to any component of the network to greatly improve efficiencies. This allows us to instantly deploy our network, automatically manages interference between nodes, and manages the load on each cell to ensure the network is operating at maximum efficiency to ensure the optimal end-user experience.

With our all-G, Open Network software-based solution, we can alleviate the concerns you outlined earlier when talking about 2G deployments. By making these networks more cost-effective to operate and maintain, and by making them future-proof towards 3G, 4G, and even 5G, we are empowering service providers to enter new markets and create additional revenue opportunities.

Since our CWS hardware has higher RF output yet consumes extremely low power, we can enable energy savings of up to 50% per site! Coupled with significant backhaul savings from our flexible backhaul capabilities via HNG, and we can greatly reduce the operators' OPEX. And because our CWS provides higher RF output, we cover larger areas with less investment, which makes it easier for service providers to fill their coverage gaps.

Another differentiator of our solution is the speed at which we can deploy. Since our software makes networks self-configuring, this enables deployments to be shortened to 2-3 hours instead of a number of days. This gives operators the ability to easily and instantly provide new services to new markets which creates additional revenue opportunities while improving the situations of previously unconnected subscribers.

By reducing the total cost to deploy 2G, we are changing the business model of deploying 2G, allowing operators to enter a new market that was otherwise cost-prohibitive.

Because this solution is fully software-based, you can easily run a software update from HNG to upgrade the CWSs from 1TRx to 2 or 4TRx as your subscriber base grows. All this can be done without replacing the hardware on-site, so you don't negatively impact your current subscribers while at the same time allowing you to increase your subscriber base!

This software-based approach also allows you to easily expand your network via virtualization. With self-optimization capabilities of HNG, you can instantly deploy new base stations to expand your coverage footprint and HNG will seamlessly and automatically manage interference between neighbors. This helps to improve the end-user experience without requiring much human intervention to expand the network. As your subscribers adapt to newer technologies such as 3G or 4G, you can use the same software-upgradable features of HNG to update your CWS to provide dual-RAT coverage so you can provide 2G today, and when your subscribers are ready to move to 3G or 4G, provide 2G/3G or 2G/4G coverage to seamlessly migrate off of your GSM network. All this can be done without replacing the hardware on-site, which improves the time to upgrade while extending your investment. By upgrading these communities' technologies, you also empower them to improve their economies by enabling new services such as access to online education, mobile health, and eCommerce.

And although many probably thought it strange that we entered the 2G arena in 2017, in doing so this allowed us to bring the benefits of our virtualized approach to legacy 2G. As a result, we can provide unique capabilities and benefits that previously did not exist on the GSM world. Because of HNG's holistic, bird's eye view into the network, we can enable seamless mobility between not only our macrocell, but also macro and small cells from other vendors—this helps further ensure subscribers are always connected. By virtualizing BSC functionality on HNG, we also have the unique ability to throttle down the satellite backhaul link during non-peak hours to optimize resource utilization and reduce OPEX. And with the SON capabilities of our software platform, we can also enable operators to gather analytics of their 2G network, a feature that until now never existed for 2G.

Because of these savings of low-cost hardware, reduced OPEX, improved deployability which enables new revenue opportunities, and the ability to deploy a 5G-ready architecture, our 2G solution has the lowest TCO which empowers MNOs to maximize the profitability of their current and future deployments. In turn, this helps to boost the economies of unconnected communities since you are essentially eliminating the disadvantages they once faced by now giving them the gift of connectivity so they can stay in touch, access online services and resources, and create new business opportunities for themselves, all enabled by you, the operator, meeting their needs of improved coverage.

You can see here some of our deployments where we were able to go in and instantly enable new coverage for these remote areas. You will notice the satellite backhaul and solar power pictured here which helps to reduce the OPEX, all enabled by our software component. You will also see a few installers in the bottom right—what is unique here is that these are local community members and not trained RF professionals. This is enabled by the simplicity our software provides, which creates this world-first opportunity for the community to assist with deployment, which creates jobs for them while reducing the installation costs for the operators.

By having 2G and 4G running over the same CWS base station, we are demonstrating how we can provide 2G access today to meet immediate subscriber needs while providing a migration plan for operators to plan ahead and bit by bit move these networks to more capable 4G and even 5G. By enabling satellite backhaul, it is much more cost-effective to provide coverage in remote areas, and with the vBSC functions of HNG, we can further reduce that cost by controlling how much satellite link is being used throughout the day. The other component on display here is the solar panel which is can lead to very significant power savings. This is made possible because of how little energy is needed to power our cell site. The last piece is our 1W outdoor cellular access point, or CAP. This allows operators to easily fill coverage gaps with little investment in not only rural markets, but in urban scenarios as well for densification.

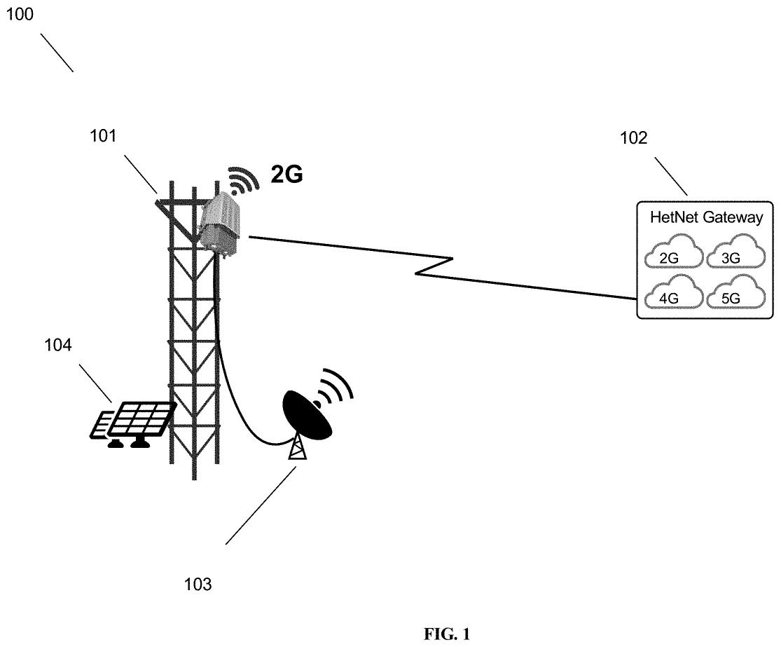

Referring to FIG. 1, a 2G over IP system 100 is shown. The system 100 includes a 2G CWS 101 in communication with a HNG 102 over a backhaul connection, which could be any of a variety of backhaul connections, e.g., fiber, microwave, cellular, etc. in some embodiments. As shown, CWS 101 is coupled to both solar panel array 104 for power and satellite dish 103 for backhaul. The CWS 101 contains a 2G BTS and Layer 1, in some embodiments, and the 2G BSC is provided by the HNG 102, in some embodiments. The CWS 101 is also capable of two or more of: 2G/3G/4G/5G/Wi-Fi, in some embodiments, and the HNG 102 provides a gateway functionality to one or more cores of each radio access technology, in some embodiments, including MOCN and virtualization.

This is energy efficient, with lower power consumption enough to be able to go on solar, and SON power management of the entire cell site. No need to replace hardware, as you can remotely upgrade from 1TRx to 2TRx or 4TRx, incl. multi-RAT support, based on the radio as configured at the factory. Virtual BSC, mobility between different vendors' macro cells, and SON-enabled 2G analytics are provided. You can see here some of our deployments where we were able to go in and instantly enable new coverage for these remote areas. You will notice the satellite backhaul 103 and solar power 104 pictured here which helps to reduce the OPEX, all enabled by our software component. You will also see a few installers in the bottom right—what is unique here is that these are local community members and not trained RF professionals. This is enabled by the simplicity our software provides, which creates this world-first opportunity for the community to assist with deployment, which creates jobs for them while reducing the installation costs for the operators.

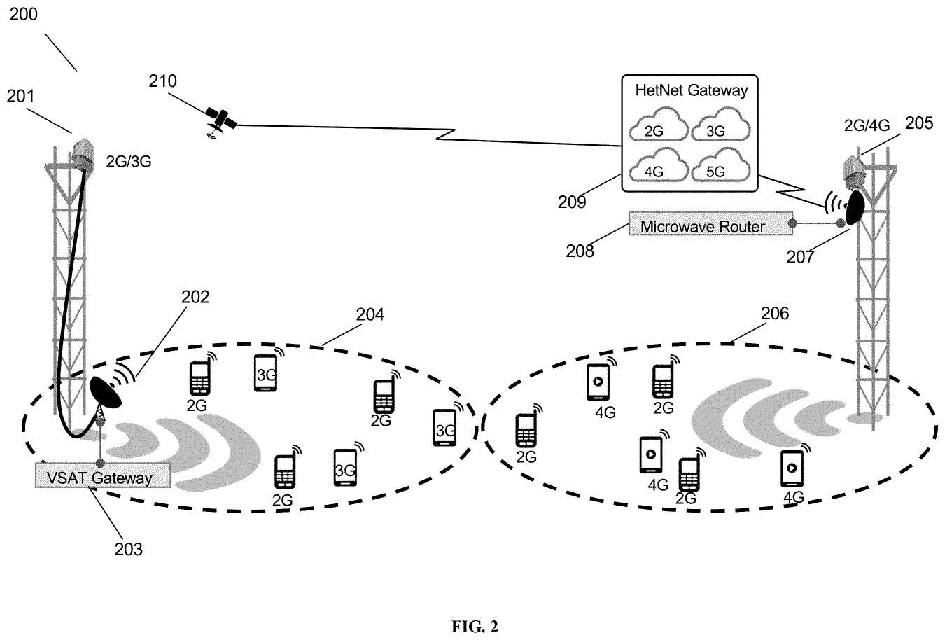

FIG. 2 shows a system 200 enabled to use either or both of satellite and microwave backhaul. System 200 includes base station 201, with coverage area 204, which provides 2G and 3G, coupled to satellite backhaul 202 and a VSAT gateway 203 for managing the satellite backhaul. 2G and 3G UEs are shown in coverage area 204. System 200 also includes 2G/4G base station 205, with coverage area 206, which covers 2G and 4G UEs. Base station 205 uses microwave backhaul dish 207 and microwave router 208. Over the backhaul connection using dish 207, base station 205 has backhaul to HetNet Gateway 209. Base station 201 is able to reach HNG 209 via satellite backhaul 202 and satellite 210. HNG 209 coordinates both base stations.

By having 2G and 4G running over the same CWS base station, we are demonstrating how we can provide 2G access today to meet immediate subscriber needs while providing a migration plan for operators to plan ahead and bit by bit move these networks to more capable 4G and even 5G. By enabling satellite backhaul, it is much more cost-effective to provide coverage in remote areas, and with the vB SC functions of HNG, we can further reduce that cost by controlling how much satellite link is being used throughout the day. The other component on display here is the solar panel which is can lead to very significant power savings. This is made possible because of how little energy is needed to power our cell site. The last piece is our 1W outdoor cellular access point, or CAP. This allows operators to easily fill coverage gaps with little investment in not only rural markets, but in urban scenarios as well for densification.

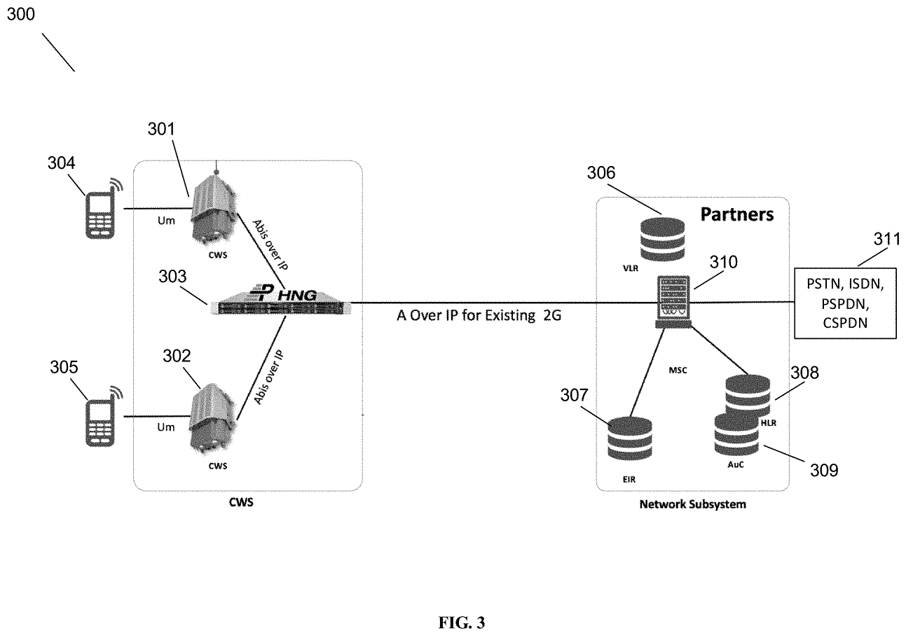

FIG. 3 shows than example architecture simplification 300. The system includes a first CWS 301 and a second CWS 302, both in communication with HNG 303. CWS 301 handles radio setup, performs time-delay measurements of received signals from the MS and some features like power management and frequency reallocation may be done with HNG coordination. CWS 301 performs radio channel setup, including: translating (in some cases transrating/encoding/decoding/transcoding) the 13 Kbps voice channel used over the radio link to the standard 2G 64 Kbps channel; assigning and releasing frequencies and time slots for the mobile station (MS); frequency hopping control; and time and frequency synchronization, in some embodiments; in some embodiments other 2G BSC functionality is also provided at CWS 301; in other embodiments, certain 2G BTS functionality is also provided at CWS 301. In some embodiments, time-delay measurements of received signals from the mobile station and coordination of power management and frequency allocation with the HNG 303 may also be performed. Full software 2G support may be provided for the 2G PHY and 2G Layer 1 as well, in some embodiments. 2G encryption may also be provided at CWS 301, in some embodiments. CWS 301 is capable of performing these operations because the processing power envelope required to provide these functions is minimal compared to the processing power available for 3G and 4G RATs, in some embodiments. The output of CWS 301 may be circuit-switched for compatibility with 2G and 3G cores, in some embodiments, in which case the A over IP interface may be used, or, in cases where voice capability at the core is provided by a packet-switched network, it may be packet-switched (for example, transformed to packet switched and delivered to a VoLTE or IMS or RTP or SIP network core), in some embodiments. The output of CWS 301 is merged into a stream of IP packets for delivery over the common backhaul connection, whatever has been provided by the operator, including the various options described herein, in some embodiments.

HNG 303 performs SON based OAM configuration, SON based power management, SON based frequency hopping, SON based channel allocation, handover, paging optimization, RTP localization (in the case of voice to RTP), perform traffic concentration to reduce the number of lines from the MSC and OAM interface via Uni-manage. A over IP is used for existing 2G between the HNG 303 and the 2G core 310. Although the core 310 is labeled MSC, it may also include a 2G BSC, in some embodiments, or, the MSC may be a 3G core, or instead of an MSC a 4G or 5G core may be used, in some embodiments, with A over IP being used to backhaul a circuit switched signal to the MSC in the 3G core, or with another interface being used to backhaul a packet switched connection from HNG 303. Various other core nodes 311 (PSTN, ISDN, PSPDN, CSPDN) are accessible via the core network 310. A 2G/3G VLR 206, an EIR 307, and an HLR 308/AuC 309 may also be provided, in some embodiments, enabling the use of 2G using a 2G core, in some embodiments, or in other embodiments enabling the use of a 2G core using a 3G core.

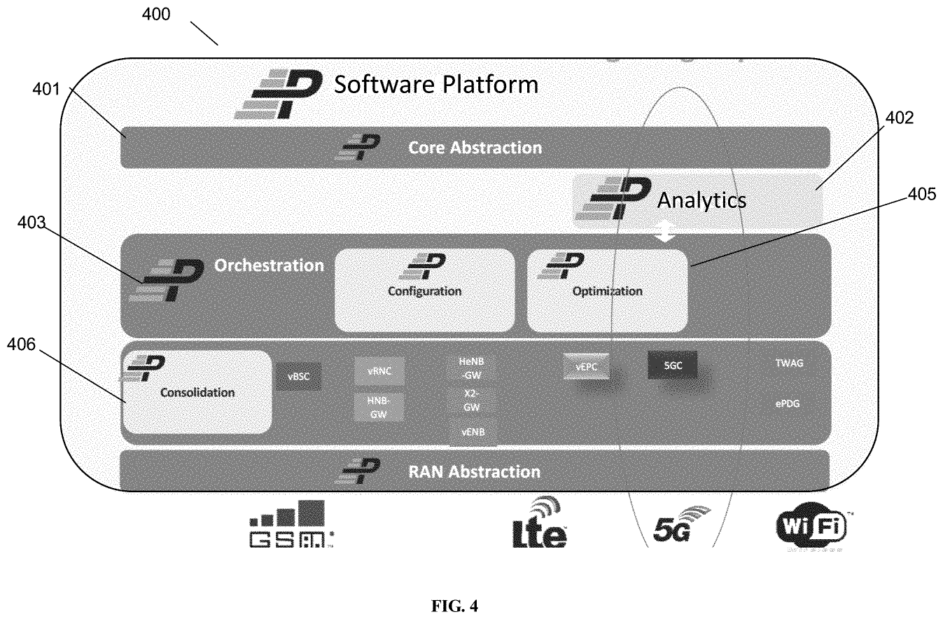

Referring to FIG. 4, an ALL G software platform 400 is shown. Platform 400 is running at a location in the network between the RAN and the core network, and includes a core abstraction 401 layer, an analytics module 402, an orchestration module 403 including at least one optimization module 404 and a configuration module 405, a consolidation layer 406, and a RAN abstraction module 407. More configuration modules and optimization modules can be provided to provide services for the different Gs. The consolidation layer 406 includes various different virtual network functions. By providing virtual network functions at the Parallel Wireless ALL G software platform, any base station with any G can be managed by the virtual network functions and not by the core network, thereby enabling effective RAN abstraction and core abstraction. For example, a virtual BSC handles 2G, a virtual RNC and Home nodeB gateway handle 3G, a home eNodeB gateway, X2 gateway, and virtual eNodeB, and if needed a virtual EPC, handle 4G/LTE, a virtual 5G core handles 5G, and a TWAG/ePDG handle Wi-Fi, in each case interworking the data from their connected base stations and UEs to be able to connect to whatever core networks are handled by the core abstraction layer 401. This unification of 2G/3G/4G RAN functionality (vBSC, vRNC, X2 gateway) under the same software umbrella coupled with orchestration capabilities enable programmable and automated RAN for savings on deployment and maintenance and will result in the best network performance for optimal subscriber experience.

By virtualizing the 5G RAN, and also all other RANs, service providers can now reduce the cost of all generations of deployments, from 2G to 5G. They can then deliver 5G coverage by making deployments easy and affordable to install and maintain, while sustaining a high quality of service for customers. Software based network architecture enables operators to utilize benefits of advanced 5G RANs without deploying the 5G core. The inventors have understood and recognized, however, that at the same time, 5G-like features (i.e. lower latency, e2e slicing, etc.) can be provided for all Gs.

For example, 5G is designed to have lower latency as one of its design goals, and consequently a 5G NR plus SGCN will provide lower latency. This lower latency is achieved partially by changing the transmit time interval (TTI)/RRC from 10 ms to 1 ms, directly reducing latency as part of the 5G radio standard; since 4G has a TTI of 10 ms, single-digit latency is not achievable. However, today's 4G networks have approximately 40 ms of latency. If the bottom limit of latency in 4G is 10 ms due to RRC, the remaining 30 ms, which may be from backhaul and non-optimized remote PGW, can be eliminated using the SGCN, which the Parallel Wireless 5G Native Architecture is positioned to do using its abstraction layer. Or, even without a SGCN, much of the benefit of latency reduction is enabled by moving the packet gateway (PGW) closer to the edge of the network, i.e., local breakout. By bringing local breakout to 4G and all Gs, 75% of the latency gains of 5G are unlocked for all Gs. Similar capabilities are able to be unlocked for all Gs, for example by providing network slicing.

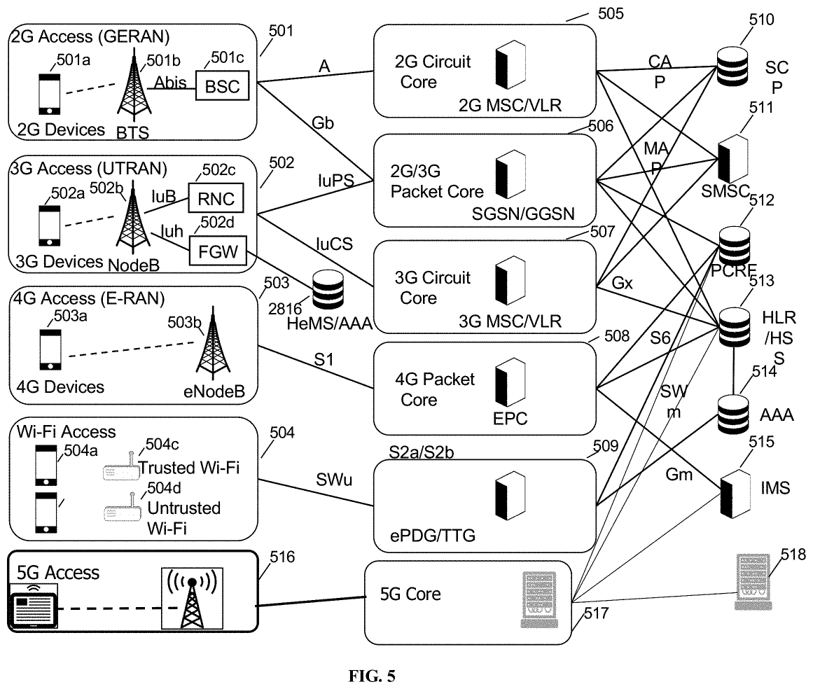

FIG. 5 is a schematic network architecture diagram for 3G and other-G prior art networks. The diagram shows a plurality of “Gs,” including 2G, 3G, 4G, 5G and Wi-Fi. 2G is represented by GERAN 501, which includes a 2G device 501a, BTS 501b, and BSC 501c. 3G is represented by UTRAN 502, which includes a 3G UE 502a, nodeB 502b, RNC 502c, and femto gateway (FGW, which in 3GPP namespace is also known as a Home nodeB Gateway or HNBGW) 502d. 4G is represented by EUTRAN or E-RAN 503, which includes an LTE UE 503a and LTE eNodeB 503b. Wi-Fi is represented by Wi-Fi access network 504, which includes a trusted Wi-Fi access point 504c and an untrusted Wi-Fi access point 504d. The Wi-Fi devices 504a and 504b may access either AP 504c or 504d. In the current network architecture, each “G” has a core network. 2G circuit core network 505 includes a 2G MSC/VLR; 2G/3G packet core network 506 includes an SGSN/GGSN (for EDGE or UMTS packet traffic); 3G circuit core 507 includes a 3G MSC/VLR; 4G circuit core 508 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 530, the SMSC 531, PCRF 532, HLR/HSS 533, Authentication, Authorization, and Accounting server (AAA) 534, and IP Multimedia Subsystem (IMS) 535. An HeMS/AAA 536 is present in some cases for use by the 3G UTRAN. The diagram is used to indicate schematically the basic functions of each network as known to one of skill in the art, and is not intended to be exhaustive. For example, 5G core 517 is shown using a single interface to 5G access 516, although in some cases 5G access can be supported using dual connectivity or via a non-standalone deployment architecture.

Noteworthy is that the RANs 501, 502, 503, 504 and 536 rely on specialized core networks 505, 506, 507, 508, 509, 537 but share essential management databases 530, 531, 532, 533, 534, 535, 538. More specifically, for the 2G GERAN, a BSC 501c is required for Abis compatibility with BTS 501b, while for the 3G UTRAN, an RNC 502c is required for Iub compatibility and an FGW 502d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

The system may include 5G equipment. 5G networks are digital cellular networks, in which the service area covered by providers is divided into a collection of small geographical areas called cells. Analog signals representing sounds and images are digitized in the phone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection.

5G uses millimeter waves which have shorter range than microwaves, therefore the cells are limited to smaller size. Millimeter wave antennas are smaller than the large antennas used in previous cellular networks. They are only a few inches (several centimeters) long. Another technique used for increasing the data rate is massive MIMO (multiple-input multiple-output). Each cell will have multiple antennas communicating with the wireless device, received by multiple antennas in the device, thus multiple bitstreams of data will be transmitted simultaneously, in parallel. In a technique called beamforming the base station computer will continuously calculate the best route for radio waves to reach each wireless device, and will organize multiple antennas to work together as phased arrays to create beams of millimeter waves to reach the device.

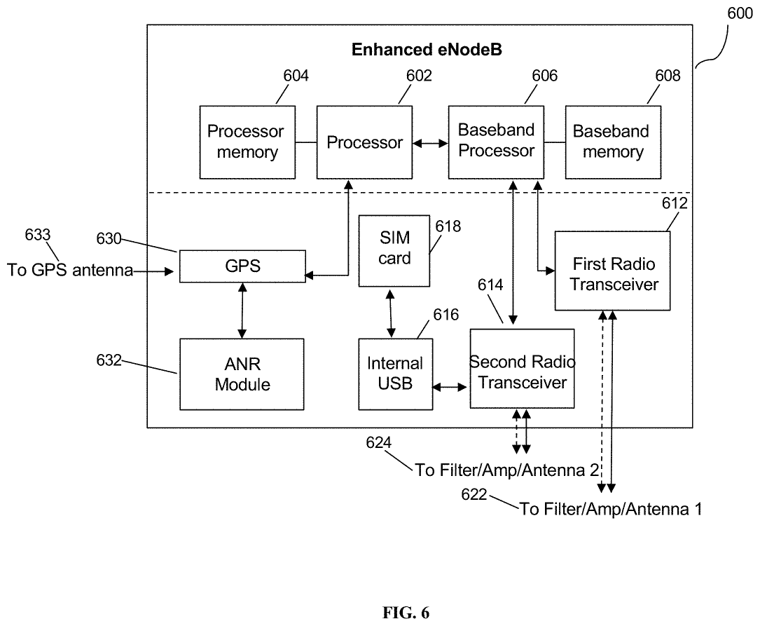

FIG. 6 shows is an enhanced eNodeB for performing the methods described herein, in accordance with some embodiments. eNodeB 600 may include processor 602, processor memory 604 in communication with the processor, baseband processor 606, and baseband processor memory 608 in communication with the baseband processor. Mesh network node 600 may also include first radio transceiver 612 and second radio transceiver 614, internal universal serial bus (USB) port 616, and subscriber information module card (SIM card) 618 coupled to USB port 616. In some embodiments, the second radio transceiver 614 itself may be coupled to USB port 616, and communications from the baseband processor may be passed through USB port 616. The second radio transceiver may be used for wirelessly backhauling eNodeB 600.

Processor 602 and baseband processor 606 are in communication with one another. Processor 602 may perform routing functions, and may determine if/when a switch in network configuration is needed. Baseband processor 606 may generate and receive radio signals for both radio transceivers 612 and 614, based on instructions from processor 602. In some embodiments, processors 602 and 606 may be on the same physical logic board. In other embodiments, they may be on separate logic boards.

Processor 602 may identify the appropriate network configuration, and may perform routing of packets from one network interface to another accordingly. Processor 602 may use memory 604, in particular to store a routing table to be used for routing packets. Baseband processor 606 may perform operations to generate the radio frequency signals for transmission or retransmission by both transceivers 610 and 612. Baseband processor 606 may also perform operations to decode signals received by transceivers 612 and 614. Baseband processor 606 may use memory 608 to perform these tasks.

The first radio transceiver 612 may be a radio transceiver capable of providing LTE eNodeB functionality, and may be capable of higher power and multi-channel OFDMA. The second radio transceiver 614 may be a radio transceiver capable of providing LTE UE functionality. Both transceivers 612 and 614 may be capable of receiving and transmitting on one or more LTE bands. In some embodiments, either or both of transceivers 612 and 614 may be capable of providing both LTE eNodeB and LTE UE functionality. Transceiver 612 may be coupled to processor 602 via a Peripheral Component Interconnect-Express (PCI-E) bus, and/or via a daughtercard. As transceiver 614 is for providing LTE UE functionality, in effect emulating a user equipment, it may be connected via the same or different PCI-E bus, or by a USB bus, and may also be coupled to SIM card 618. First transceiver 612 may be coupled to first radio frequency (RF) chain (filter, amplifier, antenna) 622, and second transceiver 614 may be coupled to second RF chain (filter, amplifier, antenna) 624.

SIM card 618 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 600 is not an ordinary UE but instead is a special UE for providing backhaul to device 600.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 612 and 614, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 602 for reconfiguration.

A GPS module 630 may also be included, and may be in communication with a GPS antenna 632 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 632 may also be present and may run on processor 602 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

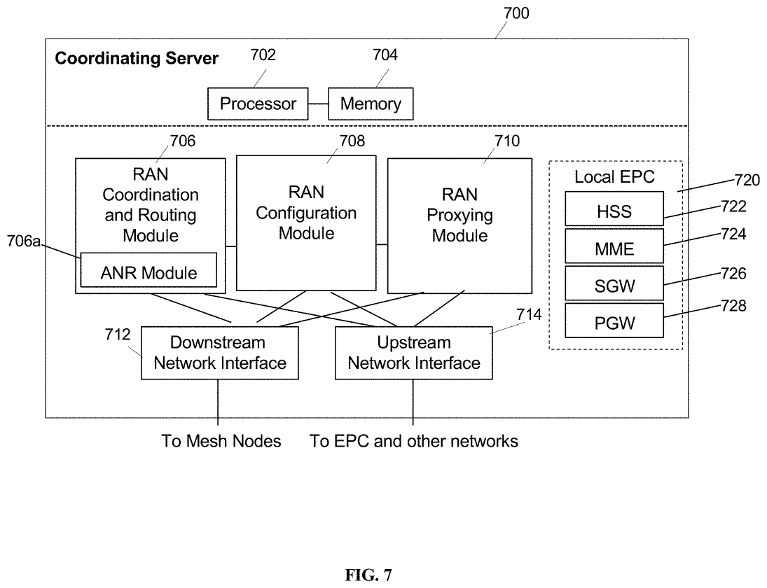

FIG. 7 shows a coordinating server for providing services and performing methods as described herein, in accordance with some embodiments. Coordinating server 700 includes processor 702 and memory 704, which are configured to provide the functions described herein. Also present are radio access network coordination/routing (RAN Coordination and routing) module 706, including ANR module 706a, RAN configuration module 708, and RAN proxying module 710. The ANR module 706a may perform the ANR tracking, PCI disambiguation, ECGI requesting, and GPS coalescing and tracking as described herein, in coordination with RAN coordination module 706 (e.g., for requesting ECGIs, etc.). In some embodiments, coordinating server 700 may coordinate multiple RANs using coordination module 706. In some embodiments, coordination server may also provide proxying, routing virtualization and RAN virtualization, via modules 710 and 708. In some embodiments, a downstream network interface 712 is provided for interfacing with the RANs, which may be a radio interface (e.g., LTE), and an upstream network interface 714 is provided for interfacing with the core network, which may be either a radio interface (e.g., LTE) or a wired interface (e.g., Ethernet).

Coordinator 700 includes local evolved packet core (EPC) module 720, for authenticating users, storing and caching priority profile information, and performing other EPC-dependent functions when no backhaul link is available. Local EPC 720 may include local HSS 722, local MME 724, local SGW 726, and local PGW 728, as well as other modules. Local EPC 720 may incorporate these modules as software modules, processes, or containers. Local EPC 720 may alternatively incorporate these modules as a small number of monolithic software processes. Modules 706, 708, 710 and local EPC 720 may each run on processor 702 or on another processor, or may be located within another device.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server, when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than S1AP, or the same protocol, could be used, in some embodiments.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

The protocols described herein have largely been adopted by the 3GPP as a standard for the upcoming 5G network technology as well, in particular for interfacing with 4G/LTE technology. For example, X2 is used in both 4G and 5G and is also complemented by 5G-specific standard protocols called Xn. Additionally, the 5G standard includes two phases, non-standalone (which will coexist with 4G devices and networks) and standalone, and also includes specifications for dual connectivity of UEs to both LTE and NR (“New Radio”) 5G radio access networks. The inter-base station protocol between an LTE eNB and a 5G gNB is called Xx. The specifications of the Xn and Xx protocol are understood to be known to those of skill in the art and are hereby incorporated by reference dated as of the priority date of this application.

In some embodiments, several nodes in the 4G/LTE Evolved Packet Core (EPC), including mobility management entity (MME), MME/serving gateway (S-GW), and MME/S-GW are located in a core network. Where shown in the present disclosure it is understood that an MME/S-GW is representing any combination of nodes in a core network, of whatever generation technology, as appropriate. The present disclosure contemplates a gateway node, variously described as a gateway, HetNet Gateway, multi-RAT gateway, LTE Access Controller, radio access network controller, aggregating gateway, cloud coordination server, coordinating gateway, or coordination cloud, in a gateway role and position between one or more core networks (including multiple operator core networks and core networks of heterogeneous RATs) and the radio access network (RAN). This gateway node may also provide a gateway role for the X2 protocol or other protocols among a series of base stations. The gateway node may also be a security gateway, for example, a TWAG or ePDG. The RAN shown is for use at least with an evolved universal mobile telecommunications system terrestrial radio access network (E-UTRAN) for 4G/LTE, and for 5G, and with any other combination of RATs, and is shown with multiple included base stations, which may be eNBs or may include regular eNBs, femto cells, small cells, virtual cells, virtualized cells (i.e., real cells behind a virtualization gateway), or other cellular base stations, including 3G base stations and 5G base stations (gNBs), or base stations that provide multi-RAT access in a single device, depending on context.

In the present disclosure, the words “eNB,” “eNodeB,” and “gNodeB” are used to refer to a cellular base station. However, one of skill in the art would appreciate that it would be possible to provide the same functionality and services to other types of base stations, as well as any equivalents, such as Home eNodeBs. In some cases Wi-Fi may be provided as a RAT, either on its own or as a component of a cellular access network via a trusted wireless access gateway (TWAG), evolved packet data network gateway (ePDG) or other gateway, which may be the same as the coordinating gateway described hereinabove.

The word “X2” herein may be understood to include X2 or also Xn or Xx, as appropriate. The gateway described herein is understood to be able to be used as a proxy, gateway, B2BUA, interworking node, interoperability node, etc. as described herein for and between X2, Xn, and/or Xx, as appropriate, as well as for any other protocol and/or any other communications between an LTE eNB, a 5G gNB (either NR, standalone or non-standalone). The gateway described herein is understood to be suitable for providing a stateful proxy that models capabilities of dual connectivity-capable handsets for when such handsets are connected to any combination of eNBs and gNBs. The gateway described herein may perform stateful interworking for master cell group (MCG), secondary cell group (SCG), other dual-connectivity scenarios, or single-connectivity scenarios.

In some embodiments, the base stations described herein may be compatible with a Long Term Evolution (LTE) radio transmission protocol, or another air interface. The LTE-compatible base stations may be eNodeBs, or may be gNodeBs, or may be hybrid base stations supporting multiple technologies and may have integration across multiple cellular network generations such as steering, memory sharing, data structure sharing, shared connections to core network nodes, etc. In addition to supporting the LTE protocol, the base stations may also support other air interfaces, such as UMTS/HSPA, CDMA/CDMA2000, GSM/EDGE, GPRS, EVDO, other 3G/2G, legacy TDD, 5G, or other air interfaces used for mobile telephony. In some embodiments, the base stations described herein may support Wi-Fi air interfaces, which may include one of 802.11a/b/g/n/ac/ad/af/ah. In some embodiments, the base stations described herein may support 802.16 (WiMAX), or other air interfaces. In some embodiments, the base stations described herein may provide access to land mobile radio (LMR)-associated radio frequency bands. In some embodiments, the base stations described herein may also support more than one of the above radio frequency protocols, and may also support transmit power adjustments for some or all of the radio frequency protocols supported.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server, when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than S1AP, or the same protocol, could be used, in some embodiments.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a 5G, or Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony. Anywhere a 4G base station is described, a 5G base station is also contemplated, in some cases as a multi-RAT base station. Anywhere a 4G core is contemplated, a 5G SA or NSA core is also contemplated, including MOCN and multiple cores for different RATs.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A virtualized Hetnet Gateway (HNG) for a 2G network, comprising:
a processor; and
a memory coupled to the processor, the memory containing instructions which, when executed by the processor, cause the base station to provide a virtual machine for 2G networks;
wherein the virtual machine provides a plurality of virtualized network functions (VNFs).

2. The virtualized HNG of claim 1, wherein a virtualized function comprises a Base Station Controller (BSC).

3. The virtualized HNG of claim 1, wherein a virtualized function comprises a Radio Network Controller (RNC).

4. The virtualized HNG of claim 1, wherein a virtualized function comprises a Self-Organizing Network (SON).

5. The virtualized HNG of claim 1, wherein the virtual machine operates with all G networks.

6. The virtualized HNG of claim 1, wherein the HNG throttles down a satellite backhaul link during non-peak hours.

7. The virtualized HNG of claim 4, wherein the SON gathers analytics of the network.

8. The virtualized HNG of claim 4, wherein the HNG provides at least one of handover, paging optimization, RTP localization., traffic concentration, and providing an OAM interface.

9. The virtualized HNG of 4, wherein the HNG provides at least one of SON based OAM, SON based power management, SON based frequency hopping and SON based channel allocation.

10. A method comprising:
causing a processor to provide a virtual machine for 2G networks;
wherein the virtual machine provide a plurality of virtualized network functions (VNFs).

11. The method of claim 10, wherein a virtualized function comprises a Base Station Controller (BSC).

12. The method of claim 10, wherein a virtualized function comprises a Radio Network Controller (RNC).

13. The method of claim lo, wherein a virtualized function comprises a Self-Organizing Network (SON).

14. The method of claim 10, wherein the virtual machine operates with all G networks.

15. The method of claim 10, wherein the HNG throttles down a satellite backhaul link during non-peak hours.

16. The method of claim 13, wherein the SON gathers analytics of the network.

17. The method of claim 13, wherein the HNG provides at least one of handover, paging optimization, RTP localization., traffic concentration, and providing an OAM interface.

18. The method of 13, wherein the HNG provides at least one of SON based OAM, SON based power management, SON based frequency hopping and SON based channel allocation.

19. A non-transitory computer-readable medium containing instructions which, when executed at a processor, causes the processor to perform steps comprising:
providing a virtual machine for 2G networks;
wherein the virtual machine provide a plurality of virtualized network functions (VNFs).
